(19) United States
(12) Patent Application Publication
(10) Pub. No.: US 2026/0304344 A1
(43) Pub. Date: Oct. 1, 2026

(54) METHODS AND APPARATUSES FOR SETTING UP PDU SESSION IN DISTRIBUTED NAS CONNECTION FOR NEXT GENERATION NETWORK

(71) Applicant: InterDigital Patent Holdings, Inc., Wilmington, DE (US)

(72) Inventors: Jung Je Son, Warrington, PA (US); Samir Ferdi, Kirkland (CA); Guanzhou Wang, Brossard (CA); Anuj Sethi, Ottawa (CA); Taimoor Abbas, Sainte-Julie (CA)

(73) Assignee: InterDigital Patent Holdings, Inc., Wilmington, DE (US)

(21) Appl. No.: 19/092,676

(22) Filed: Mar. 27, 2025

(51) Int. Cl. H04W 60/04; H04W 28/02; H04W 76/12

(52) U.S. Cl. CPC H04W 60/04; H04W 28/0268; H04W 76/12

(57) ABSTRACT

A method may be used by a radio access network node. The method comprises receiving a first registration request from a wireless transmit/receive unit (WTRU) including a requested network slice. The method comprises sending a second registration request, including information indicating the requested network slice. The method comprises receiving a first registration response, including information indicating allowed network slice information. and sending a second registration response, including allowed network slice information. The method comprises receiving a first protocol data unit (PDU) session setup response including quality of service (QoS) flow and QoS parameter information associated with an allowed network slice. The method comprises setting up a user plane tunnel between the RAN node and a gateway associated to a default PDU session and sending a second PDU session setup response to the WTRU including information regarding assigned QoS flows for a default data name network for the allowed network slice.

### BACKGROUND

In a 5G system architecture, network functions (NFs) (e.g., Access and Mobility Management Function (AMF), Session Management Function (SMF), Unified Data Management (UDM)) may communicate with each other using a Service Based Interface (SBI), using protocols such as hypertext transfer protocol (HTTP). The goal of the Service Base Architecture (SBA) is to enable NFs to expose services (e.g., using RESTful application programming interfaces (APIs)) to other NFs, for the system to provide the desired functionality.

### SUMMARY

A method may be used by a radio access network (RAN) node. The method may comprise receiving a first registration request from a wireless transmit/receive unit (WTRU). The first registration request may comprise a requested network slice. The method may comprise sending a second registration request. The second registration request may comprise information indicating the requested network slice. The method may comprise receiving a first registration response. The first registration response may comprise information indicating allowed network slice information. The method may comprise sending a second registration response. The second registration response may comprise allowed network slice information. The method may comprise receiving a first protocol data unit (PDU) session setup response. The first PDU session setup response may comprise quality of service (QoS) flow and QoS parameter information associated with an allowed network slice. The method may comprise setting up a user plane tunnel between the RAN node and a gateway associated to a default PDU session. The method may comprise sending a second PDU session setup response to the WTRU. The second PDU session setup response may comprise information regarding assigned QoS flows for a default data name network (DNN) for the allowed network slice. The first registration request may comprise a WTRU identification. The first registration request may comprise an indication that a default PDU session is requested. The second registration request may comprise information for N3 tunnel setup for the default PDU session for the requested network slice. The second registration request may be sent to an Access and Mobility Function (AMF). The first registration response may be received from the AMF. The first registration response may comprise Session Management Function (SMF) information for default data network name (DNN) for an allowed network slice. The method may comprise forwarding PDU session management messages based on the SMF information. The first PDU session setup response may be received from a Session Management Function (SMF). The first PDU session setup response may be a session management (SM) non-access stratum (NAS) message. The first PDU session setup response may comprise User Plane Function (UPF) tunnel endpoint information.

A radio access network (RAN) node may be configured to receive a first registration request from a wireless transmit/receive unit (WTRU). The first registration request may comprise a requested network slice. The RAN node may be configured to send a second registration request. The second registration request may comprise information indicating the requested network slice. The RAN node may be configured to receive a first registration response. The first registration response may comprise information indicating allowed network slice information. The RAN node may be configured to send a second registration response. The second registration response may comprise allowed network slice information. The RAN node may be configured to receive a first a protocol data unit (PDU) session setup response message. The first PDU session setup response may comprise quality of service (QoS) flow and QoS parameter information associated with an allowed network slice. The RAN node may be configured to set up a user plane tunnel between the RAN node and a gateway associated to a default PDU session. The RAN node may be configured to send a second PDU session setup response to the WTRU. The second PDU session setup response may comprise information regarding assigned QoS flows for a default data name network (DNN) for the allowed network slice. The first registration request may comprise a WTRU identification. The first registration request may comprise an indication that a default PDU session is requested. The second registration request may comprise information for N3 tunnel setup for the default PDU session for the requested network slice. The second registration request may be sent to an Access and Mobility Function (AMF). The first registration response may be received from the AMF. The first registration response may comprise Session Management Function (SMF) information for default data network name (DNN) for an allowed network slice. The RAN node may be configured to forwarding PDU session management messages based on the SMF information. The first PDU session setup response may be received from a Session Management Function (SMF). The first PDU session setup response may be a session management (SM) non-access stratum (NAS) message. The first PDU session setup response may comprise User Plane Function (UPF) tunnel endpoint information.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows a simplified version of the 5G System Architecture;

FIG. 3 shows an example Control Plane stack between the WTRU and the AMF;

FIG. 4 shows an example procedure for default PDU session setup by an AMF after registration;

FIG. 5 shows an example procedure for default PDU session setup by AMF after registration with optimized N3 tunnel setup;

FIG. 6 shows an example procedure for use in a RAN node for default PDU session setup after registration with optimized N3 tunnel setup;

FIG. 7 shows an example procedure for use in an AMF for default PDU session setup after registration with optimized N3 tunnel setup;

FIG. 8 shows an example procedure for default PDU session setup by a RAN node per allowed network slice;

FIG. 9 shows an example procedure for use in a RAN node for default PDU session setup by a RAN node per allowed network slice; and

FIG. 10 shows an example procedure for use in an AMF for default PDU session setup by a RAN node per allowed network slice.

### DETAILED DESCRIPTION

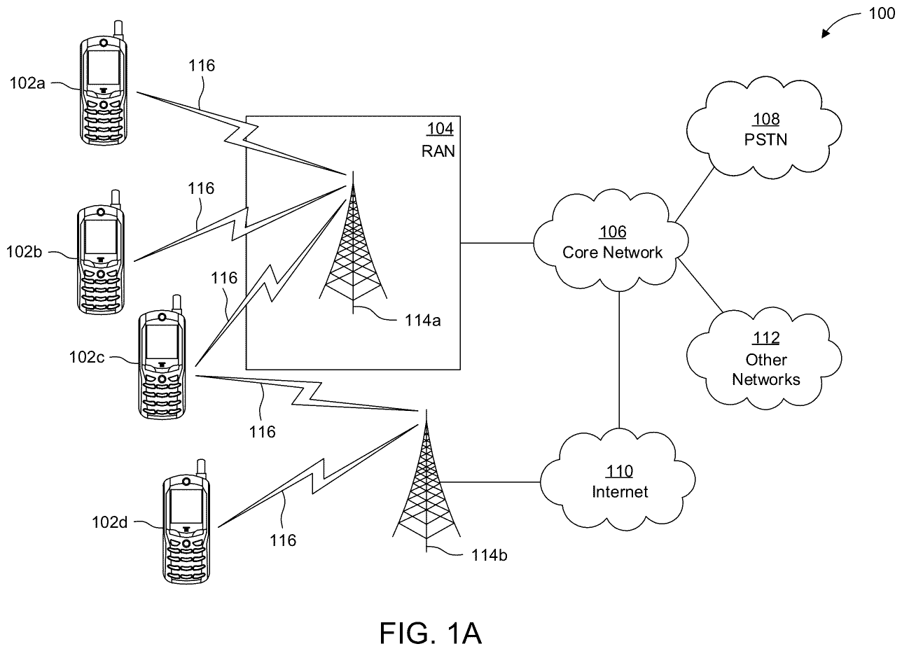

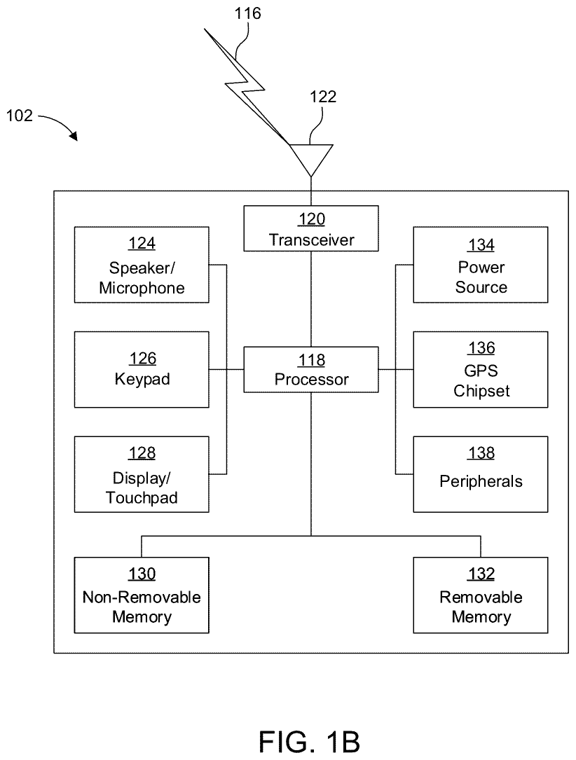

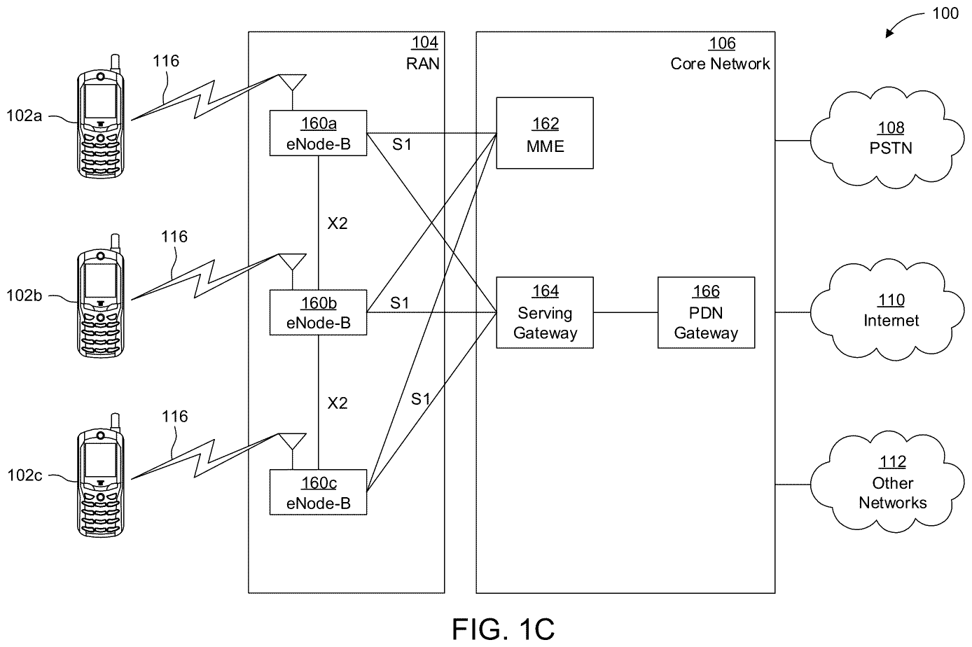

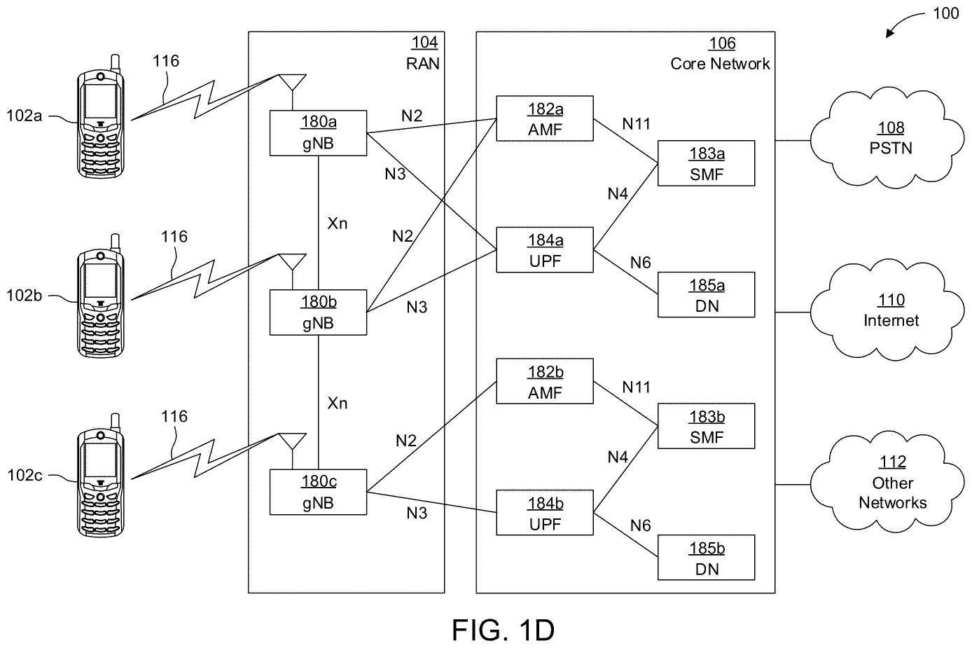

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

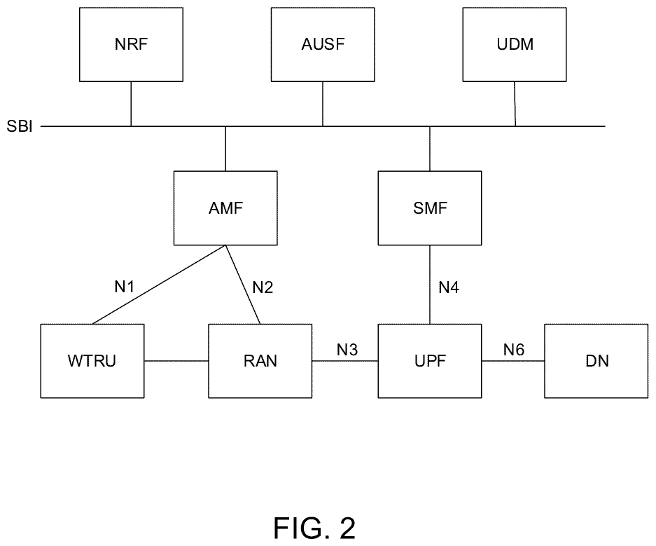

FIG. 2 shows a simplified version of the 5G System Architecture where only a subset of the NFs in the 5G Core are represented. FIG. 2 shows a WTRU, a Radio Access Network (RAN), a User Plane Function (UPF), a Data Network (DN), an Access and Mobility Management Function (AMF), a Session Management Function (SMF), Unified Data Management (UDM), a Network Repository Function (NRF), and an Authentication Server Function (AUSF). FIG. 2 also shows an N1 interface between the WTRU and AMF, an N2 interface between the RAN and AMF, an N3 interface between the RAN and UPF, and N4 interface between the UPF and SMF, and an N6 interface between the UPF and DN. The other interfaces (Nx) shown in FIG. 2 and described below are different from the Service Base Interface (SBI).

The WTRU may communicate with the AMF over N1 using a non-access stratum (NAS) protocol. Control plane messaging between the WTRU and other NFs (e.g., SMF) may be done using NAS transport encapsulation mechanism provided by the AMF for the NFs.

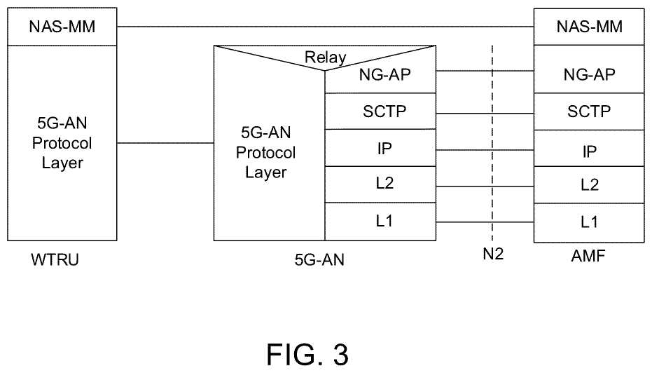

FIG. 3 shows an example Control Plane stack between the WTRU and the AMF. As shown in FIG. 3, RAN communicates with the AMF over N2 using a Next Generation Application Protocol (NGAP) protocol. Control plane messaging between the WTRU and RAN (Access Stratum (AS)) is done using radio resource control (RRC) (i.e., top of the 5G-AN protocol layers) which is used to transport NAS messages received or sent by RAN over N2.

The Next Generation Network architecture is expected to continue and push further the shift started in 5G to embrace a cloud native implementation in the Core Network (CN). The push to bring core network user plane and other functions always closer to the edge will continue to be motivated by the need to support ever increasing traffic levels and lower latencies (e.g., extended reality (XR), meta-verse, artificial intelligence and machine learning (AIML)). With this major trend the possibility to extend SBA to the RAN emerges to simplify the network architecture while taking advantage of cloud native and micro-service architectures capabilities (e.g., scalability, elasticity, open interfaces).

For example, new architecture proposals are emerging with the possibility to extend the SBI framework beyond the 5GC NFs (as shown in FIG. 2). For example, a WTRU may use an evolved NAS mechanism to exchange NAS messages directly with one or more NFs. As an example, an SBI compliant WTRU may establish an application layer communication directly with an NF (e.g., SMF) without going through the AMF (i.e., instead of via N1).

In another trend, the next generation network is touted as bringing about the so called “connected intelligence” where intelligent networks using AIML technology will be able to connect a multitude of “intelligent” things. With huge amount of data collection from a multitude of devices (e.g., sensors, Ambient Internet of Things (IoT)) and with the added high flexibility and adaptability of AIML enabled functionalities, the system will pave the way for new advanced applications such as XR/Metaverse.

In a 5G environment, a WTRU may request several network (NW) slices for a dedicated service environment during a registration procedure. After registration, for each NW slice, a PDU session establishment may be performed separately using an associated data network name (DNN). In a PDU session establishment, the AMF may discover/select a proper SMF per a DNN/Single Network Slice Selection Assistance Information (S-NSSAI) combination and route the session management (SM) NAS message to the discovered SMF.

A current 5G NAS scheme concentrates the signaling towards the AMF, which increases the risk of NAS congestion at the AMF.

As an alternative, the next generation network evolution, distributed NAS (direct communication between WTRU/RAN and each NF (SMF, PCF, etc.)) may be considered. But, in this case, how the WTRU/RAN may communicate with different SMFs per NW slice is not specified.

An open problem is that in a distributed NAS environment for the future wireless networks, how can the WTRU and network efficiently handle the PDU session establishment for supported network slices.

As a method to reduce signaling and latency, for each NW slice, a default PDU session may be utilized. A default PDU session assumes pre-configured parameters for setting the PDU session, which may reduce signaling when it is merged into NW slice authorization.

Even in a next generation network evolution, a default PDU session setup for each NW slice should be supported for efficient connection setup.

In an embodiment, a default PDU session setup with optimized N3 tunnel setup may be used.

A RAN node may perform one or more of the following. The RAN node may receive a registration request message from a WTRU with requested network slices with an indication whether a default PDU session is preferred. The RAN node may send a registration request message to an AMF with the requested network slices and additional information for N3 tunnel setup (access network (AN) tunnel information) for a default PDU session for the requested network slice if the WTRU indicated that a default PDU session is preferred for the requested network slice. The RAN node may receive a message (e.g., signaling message) including a registration response with the allowed network slice to the WTRU and SMF information for default DNN for the allowed network slice. The RAN node may send a registration response message to the WTRU with the allowed network slice. The RAN node may receive a PDU session setup response message from the SMF which is informed from AMF for the default PDU session for the allowed network slice for the WTRU. The RAN node may set up an N3 tunnel based on received CN tunnel information for the default PDU session. The RAN node may send a PDU session setup response message to the WTRU.

An AMF may perform one or more of the following. The AMF may receive a registration request message from the WTRU with the requested network slices. The AMF may authorize the WTRU for the registration request and determine the allowed network slices. For each allowed network slice, the AMF may check or determine whether a default PDU session is preferred or indicated by the WTRU and the relevant information (e.g., default DNN, default PDU session parameters). The AMF may discover an SMF for the default PDU session parameters. The AMF may send a registration response message with the allowed network slice and SMF information for default DNN for the allowed network slice to the RAN node. The AMF may initiate a request for a default PDU session setup for the allowed network slice.

In an embodiment, a default PDU session setup by the RAN per allowed NW slice may be used.

The RAN node may perform one or more of the following. The RAN node may receive a registration request message from a WTRU with requested network slices. The RAN node may send a registration request message to the AMF with the requested network slices. The RAN node may receive a message (e.g., signaling message) including a registration response with the allowed network slices to the WTRU and SMF information for default DNNs for the allowed network slices. The RAN node may store a mapping or association between SMF information, DNN information, and allowed network slice (which may be optional). The RAN node may send a registration response message to the WTRU with the allowed network slice. The RAN node may receive a PDU session setup request message from the WTRU for default DNN for the allowed network slice. The RAN node may select an SMF based on the stored mapping or association between the SMF and DNN information. The RAN node may send a PDU session setup request message to the selected SMF and store a mapping or association between the PDU session ID, DNN information, and SMF information. The RAN node may receive a PDU session setup response message from the SMF. The RAN node may send a PDU session response message to the WTRU.

An AMF may perform one or more of the following. The AMF may receive a registration request message from the WTRU with requested network slices. The AMF may authorizing the WTRU for the registration request and may determine the allowed network slice. The AMF may discover an SMF for the default PDU session for the allowed network slice. The AMF may send a registration response message with the allowed network slice and SMF information for the default DNN for the allowed network slice to the RAN node.

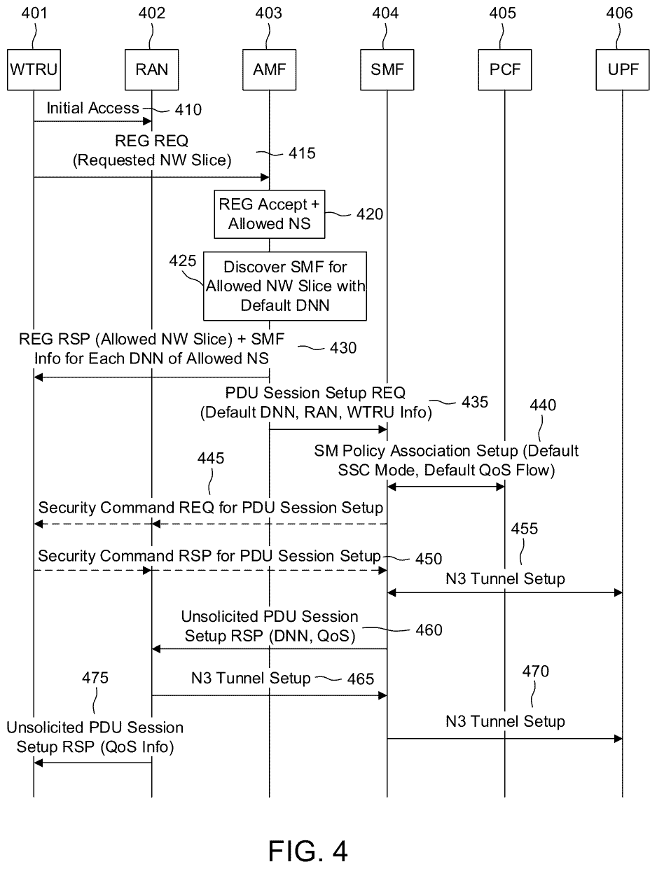

FIG. 4 shows an example procedure for default PDU session setup by an AMF after registration.

When a WTRU 401 enters a new service area, the WTRU may perform an initial access procedure 410 with a RAN node 402 (e.g., gNB).

After the initial access procedure with the RAN node, the WTRU may send a registration request (REG REQ) message 415 to the network (e.g., AMF 403) for initial registration via, for example the RAN node. The registration request message may include the WTRU's identification information and requested network (NW) slice(s) information which the WTRU wants to get communication services. For each requested network slice, the WTRU may indicate whether a default PDU session is preferred or requested.

The AMF 403 may verify whether the WTRU may register at the network 420. If needed (e.g., there is no established security context for the WTRU with the network or the security context for the WTRU with the network has expired), an authentication and authorization procedure may be performed by the network function with the WTRU via the AMF. The AMF may check or determine the allowed network slice information for the WTRU (e.g., with another NW function if the network slice context is authorized and/or managed by the other NW function.).

The AMF may check or determine a default DNN and default PDU session parameter information for each allowed network slice information. Based on the default DNN and default PDU session parameter information, the AMF may discover 425 an SMF 404 which controls the PDU session for the default DNN of the allowed network slice and may select the proper SMF to control the PDU session for the WTRU. (e.g. based on various factor such as load, location, etc.).

When the AMF selects the proper SMF, if the discovered SMF has a service area, the AMF may also verify the service area of the SMF that may serve the WTRU.

The AMF may send a registration response (REG RES) message 430 with the allowed network slice(s) information to the WTRU via the RAN node. When the AMF sends the registration response message, the AMF may send discovered SMF information for the default DNN for each allowed network slice of the WTRU to the RAN node.

The RAN node may utilize the SMF information received for forwarding PDU session management signaling for the WTRU or other PDU session establishment signaling for the DNN from other WTRUs.

If the WTRU has indicated to prefer or request a default PDU session for the requested network slice (e.g., in step 415), or based on a local configuration that such default PDU session for the network slice is preferred, the AMF may send a default PDU session setup request (REQ) message 435 to the selected SMF for each allowed network slice. The PDU session setup request message may include the WTRU's information and the RAN node's information (e.g. WTRU's serving gNB information).

There may be a configuration for each network slice whether to use a default PDU session. If a network slice is configured not to use a default PDU session, the AMF may not send the PDU session setup request message for the network slice.

After receiving the PDU session setup request message, the SMF may retrieve PDU session parameters 440 for a default DNN from the PCF 405. The PDU session parameters may be, for example, session and service continuity (SSC) mode and/or quality of service (QoS) flows (e.g., default QoS flow).

For the same default DNN, different PDU session parameters may be configured for different WTRU (e.g. based on the WTRU's network slice usage pattern and/or different WTRU's role in the service).

After receiving the PDU session setup request message, the SMF may send a security command request (REQ) message 445 for PDU session setup to the WTRU via the RAN node using the received information from the AMF if a security procedure is needed for authorization of a PDU session (e.g., for secondary authentication/authorization for the PDU session).

The WTRU may send a security commend response (RSP) message 450 to the SMF to proceed with the security procedure required for the PDU session setup. If needed, the WTRU and the SMF may further exchange signaling messages for the security procedure.

Based on the PDU session parameters, the SMF may select a UPF 406 for traffic handling for the PDU session and request an N3 tunnel setup for the WTRU's PDU session 455.

The SMF may initiate a connection setup with the RAN node based on received information from the AMF, if there is no connection established between the RAN node and the SMF. If Service Based interface is used, the SMF may send a service request message for transporting a Session Management (SM) NAS message using the received RAN node's information from the AMF.

Over the connection between the SMF and the RAN node (e.g. dedicated connection or service-based interface), the SMF may send a SM NAS message including a PDU session setup response (RSP) 460 for the WTRU to the RAN node. In the PDU session setup response, QoS flow and QoS parameter information may be included. The UPF's tunnel end point information (CN tunnel info) may be included as additional information sent to RAN node.

After receiving the CN tunnel info, the RAN node may send uplink traffic to the UPF using the UPF's tunnel end point information.

The RAN node may send a message for N3 tunnel setup 465 to the SMF. The message may include the RAN node's tunnel end point information (AN tunnel info) for the PDU session.

The SMF may send the received N3 tunnel end point (AN tunnel info) 470 from the RAN node to the UPF.

The RAN node may send a PDU session setup response (RSP) message 475, received from the SMF in 460, to the WTRU. The PDU session setup response message may include assigned QoS flows for the default DNN and other associated parameters. In the future when the WTRU initiates a communication request (e.g., launching an application) and the required PDU session parameters (DNN, network slice, etc.) based on the local policies (e.g. user requested slice path (URSP)) matches that of the default PDU Session, the WTRU may use the default PDU session for the communication.

In an embodiment, after receiving the PDU session setup response message, the WTRU may send an SM NAS message for confirmation of the PDU session setup and additional information (e.g. to SMF)

In an embodiment, a security procedure for the PDU session setup including steps 445 and 450, and further steps may be performed after step 475. Until a successful security procedure, the assigned PDU session may be used in limited scope (e.g., carrying packet for performing security procedures over user plane, etc.).

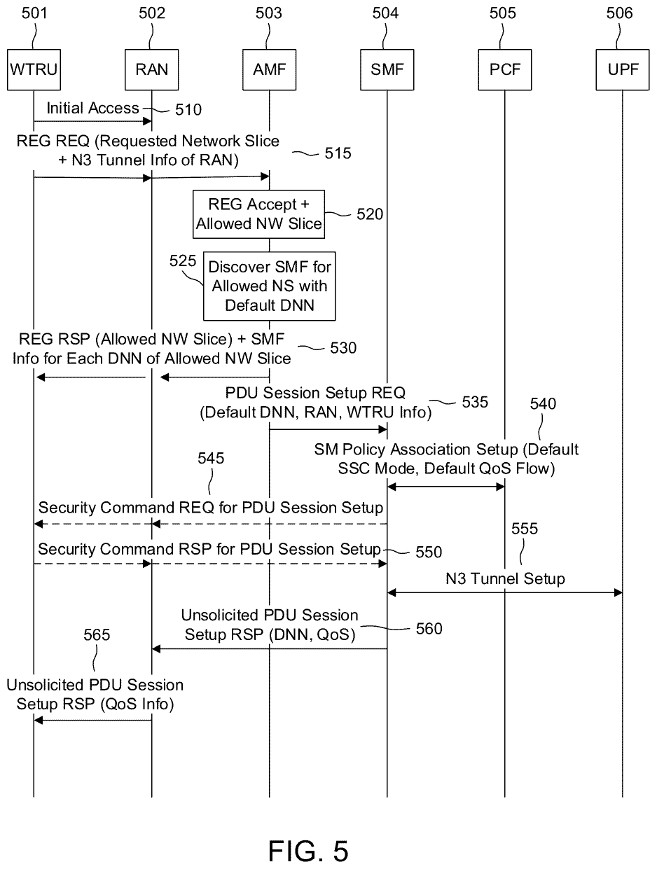

FIG. 5 shows a procedure for default PDU session setup by an AMF with optimized N3 tunnel setup.

When a WTRU 501 enters a new service area, the WTRU may perform an initial access procedure 510 with a RAN node 502 (e.g., gNB).

After the initial access procedure with the RAN node, the WTRU may send a registration request (REG REQ) message 515 to the network (e.g., AMF 503) for initial registration. The registration request message may include the WTRU's identification information and requested network slice(s)information for which the WTRU wants to get communication services. For each requested network slice, the WTRU may indicate whether a default PDU session is preferred or requested.

When sending the registration request to the AMF, the RAN node may include N3 tunnel information of the RAN node (AN tunnel info) for the WTRU per the requested network slice, based on a pre-configuration by network or based on the indication whether a default PDU session is preferred for each requested network slice.

The AMF 503 may verify whether the WTRU may register at the network 520. If needed (e.g., there is no established security context for the WTRU with the network or the security context for the WTRU with the network has expired), an authentication and authorization procedure may be performed by the network function with the WTRU via the AMF. The AMF may check or determine the allowed network (NW) slice information for the WTRU (with another NW function if the network slice context is authorized and/or managed by the other NW function.).

The AMF may check or determine a default DNN and default PDU session parameter information for each allowed network slice information. Based on the default DNN and default PDU session parameter information, the AMF may discover 525 an SMF 504 which control the PDU session for the default DNN of the allowed network slice and select a proper SMF to control the PDU session for the WTRU. (e.g. based on various factor such as load, location, etc.).

When the AMF selects the proper SMF, if the discovered SMF has a service area, the AMF may also verify the service area of the SMF may serve the WTRU.

The AMF may send a registration response (REG RSP) message 530 with allowed network slice(s) information to the WTRU via the RAN node. When the AMF sends a registration response, the AMF may send discovered SMF information for the default DNN for each allowed network slice of the WTRU to the RAN node.

The RAN node may utilize the SMF information received for forwarding PDU session management signaling for the WTRU or other PDU session establishment signaling for the DNN from other WTRUs.

If the WTRU has indicated to prefer or request a default PDU session for the requested network slice (e.g., in step 515), or based on a local configuration that such default PDU session for the network slice is preferred, the AMF may send a default PDU session setup request (REQ) message 535 to the selected SMF for each allowed network slice. The PDU session setup request may include the WTRU's information and the RAN node's information (e.g. WTRU's serving gNB information). The PDU session setup request may include the RAN node's N3 tunnel information for the WTRU.

There may be a configuration for each network slice whether to use a default PDU session. If a network slice is configured not to use the default PDU session, the AMF may not send the PDU session setup request for the network slice.

After receiving the PDU session setup request message, the SMF may retrieve the PDU session parameters 540 for default DNN from the PCF 505. The PDU session parameters may be, for example, SSC mode and/or QoS flows (e.g., default QoS flow).

For the same default DNN, different PDU session parameters may be configured for different WTRU (e.g. based on the WTRU's network slice usage pattern and/or different WTRU's role in the service).

After receiving the PDU session setup request message, the SMF may send a security command request (REQ) message 545 for PDU session setup to the WTRU via the RAN node using the received information from the AMF (e.g., for secondary authentication/authorization for the PDU session).

The WTRU may send a security command response (RSP) message 550 to the SMF to proceed with the security procedure required for the PDU session setup. If needed, the WTRU and SMF may further exchange signaling messages for the security procedure.

After successful completion of security procedure, the SMF may perform step 550, if the security procedure is needed.

Based on the PDU session parameters, the SMF may select a UPF 506 for traffic handling for the PDU session and request an N3 tunnel setup for the WTRU's PDU session using the RAN node's N3 tunnel information. Based on the RAN node's N3 tunnel information, the UPF may setup the N3 tunnel with the RAN node for downlink traffic 555.

The SMF may initiate a connection setup with the RAN node based on the received information from the AMF, if there is no connection established between the RAN node and the SMF. If Service Based interface is used, the SMF may send a service request message for transporting a Session Management (SM) NAS message using the received RAN node's information from the AMF.

Over the connection between the SMF and RAN node (e.g., dedicated connection or service-based interface), the SMF may send an SM NAS message 560 including a PDU session setup response (RSP) for the WTRU to the RAN node. In the PDU session setup response, QoS flow and QoS parameter information may be included. The UPF's tunnel end point information may be included as additional information sent to the RAN node.

After receiving the CN tunnel info, the RAN node may send uplink traffic to the UPF using the UPF's tunnel end point information.

The RAN node may send a PDU session setup response (RSP) message 565, received in step 560, to the WTRU. The message may include assigned QoS flows for the default DNN and other associated parameters.

When N3 tunnel information of the RAN node for the WTRU is assigned by the RAN node, for each requested network slice from the WTRU in the registration request, the RAN node may preassign a DL tunnel ID for a default PDU session for each network slice. The preassigned information may be shared to the AMF in step 515. The AMF may share each N3 tunnel information of the RAN node for the default PDU session to each corresponding SMF. In this case, after receiving a registration response, the RAN node may release the preassigned DL tunnel ID for a rejected network slice or may activate a pre-assigned DL tunnel ID only for the allowed network slice. If the RAN node receives traffic over the DL tunnel ID which is released or not activated, the RAN node may ignore the traffic.

In an embodiment, there may be a configuration by an operator or network how to differentiate tunnels between different PDU sessions per network slice for the WTRU. For example, there may be pre-configuration on the port number used for the PDU session per default DNN per network slice. In an embodiment, additional ID per PDU session per network slice may be appended to the N3 tunnel info from the RAN node to differentiate PDU sessions per network slice.

In an embodiment, after receiving a PDU session setup response message, the WTRU may send an SM NAS message for confirmation of the PDU session setup and additional information (e.g. to SMF).

In an embodiment, a security procedure for PDU session setup including steps 545 and 550, and further steps may be performed after step 565. Until a successful security procedure, the assigned PDU session may be used in limited scope (e.g., carrying packets for performing security procedures over user plane).

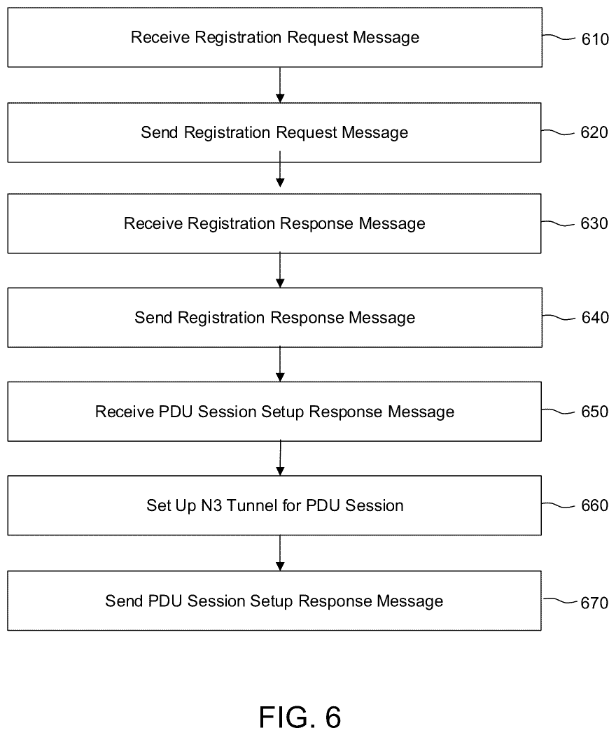

FIG. 6 shows an example procedure for use in a RAN node for default PDU session setup after registration with optimized N3 tunnel setup.

A RAN node may receive a registration request message 610. The registration request message may be received from a WTRU. The registration request message may include the WTRU's identification information. The registration request message may include requested network slices. The registration request message may include an indication that a default PDU session is preferred or requested. For each requested network slice, the WTRU may indicate whether a default PDU session is preferred or requested. The RAN node may receive the registration request message after an initial access procedure is performed with the WTRU.

The RAN node may send a registration request message 620. The RAN node may send the registration request message to an AMF. The registration request message may include information indicating the requested network slices. The registration request message may include information for N3 tunnel setup (access network (AN) tunnel information) for a default PDU session for the requested network slice if the WTRU indicated that a default PDU session is preferred for the requested network slice. The RAN node may determine whether to include the N3 tunnel information based on a pre-configuration by network or based on the indication whether a default PDU session is preferred per requested network slice.

The RAN node may receive a registration response message (e.g., signaling message) 630. The RAN node may receive the registration response message from the AFM. The registration response message may include the allowed network slice information. The registration response message may include SMF information for default DNN for the allowed (each) network slice.

The RAN node may utilize the SMF information received for forwarding PDU session management signaling for the WTRU or other PDU session establishment signaling for the DNN from other WTRUs.

The RAN node may send a registration response message 640 to the WTRU with the allowed network slice information.

The RAN node may receive a PDU session setup response message 650. The RAN node may receive the PDU session setup response message from the SMF. The PDU session setup response message may be a session management (SM) NAS message. The PDU session setup response message may include information, from AMF, for the default PDU session for the allowed network slice for the WTRU. The PDU session setup response message may include QoS flow and QoS parameter information associated with the allowed network slice. The PDU session setup response message may include a UPF's tunnel endpoint information. After receiving the CN tunnel info, the RAN node may send uplink traffic to the UPF using the UPF's tunnel end point information.

The RAN node may set up a tunnel 660 based on received CN tunnel information for the default PDU session. The tunnel may a be a user plane tunnel between the RAN node and a gateway associated to a (e.g., the default) PDU session. The tunnel may be an N3 tunnel.

The RAN node may send a PDU session setup response message 670. The RAN node may send the PDU session setup response message to the WTRU. The PDU session setup response message may include QoS information including assigned QoS flows for the default DNN and other associated parameters for the allowed network slice.

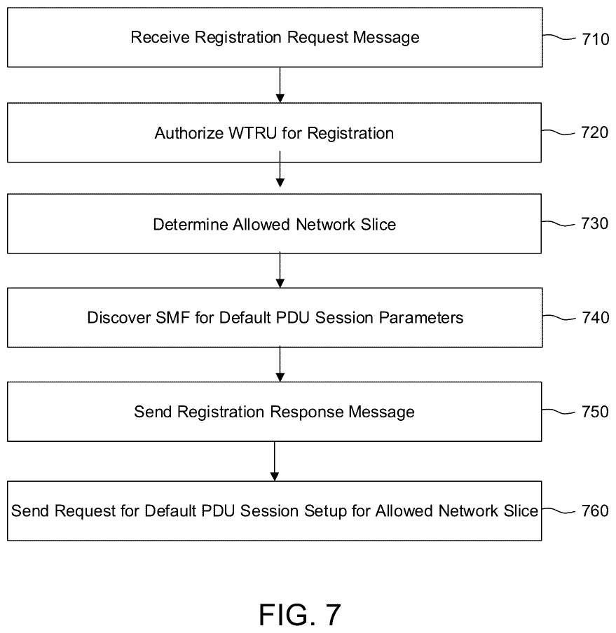

FIG. 7 shows an example procedure for use in an AMF for default PDU session setup after registration with optimized N3 tunnel setup.

The AMF may receive a registration request message 710. The registration request message may be from a WTRU. The registration request message may be received from a RAN node on behalf of the WTRU (i.e. the registration request message is sent from the WTRU to the RAN node, which forwards the message to the AMF). The registration request message may include requested network slices (e.g., requested from the WTRU). The registration request message may include the WTRU's identification information and requested network slice(s)information for which the WTRU wants to get communication services. For each requested network slice, the WTRU may indicate whether a default PDU session is preferred or requested. The registration request message may include N3 tunnel information of the RAN node (AN tunnel info) for the WTRU.

The AMF may verify whether the WTRU may register at the network. If needed, an authentication and authorization procedure may be performed by the network function with the WTRU via the AMF. The AMF may check or determine the allowed network (NW) slice information for the WTRU (with other NW function if needed).

The AMF may authorize the WTRU for the registration request 720. The AMF may determine the allowed network slices 730. For each allowed network slice, the AMF may check or determine whether a default PDU session is preferred or indicated by the WTRU and the relevant information (e.g., default DNN, default PDU session parameters).

Based on the default DNN and default PDU session parameter information, the AMF may discover an SMF which control the PDU session for the default DNN of the allowed network slice and select a proper SMF to control the PDU session for the WTRU. (e.g. based on various factor such as load, location, etc.).

The AMF may discover an SMF for the default PDU session parameters 740. Based on the default DNN and default PDU session parameter information, the AMF may discover the SMF which control the PDU session for the default DNN of the allowed network slice and select a proper SMF to control the PDU session for the WTRU. (e.g. based on various factor such as load, location, etc.).

If the SMF has a service area, the AMF may also verify the service area of the SMF may serve the WTRU.

The AMF may send a registration response message 750. The registration response message may be sent to the RAN node and/or WTRU. The registration response message may include the allowed network slice and SMF information for default DNN for the allowed network slice to the RAN node.

The AMF may send a request for a default PDU session setup for the allowed network slice 760. The AMF may send a request for a default PDU session setup if the WTRU has indicated to prefer or request a default PDU session for the requested network slice, or based on a local configuration that such default PDU session for the network slice is preferred, The AMF ay send a request for a default PDU session setup to the selected SMF for each allowed network slice. The PDU session setup request may include the WTRU's information and the RAN node's information (e.g. WTRU's serving gNB information). The PDU session setup request may include the RAN node's N3 tunnel information for the WTRU.

There may be a configuration for each network slice whether to use a default PDU session. If a network slice is configured not to use the default PDU session, the AMF may not send the PDU session setup request for the network slice.

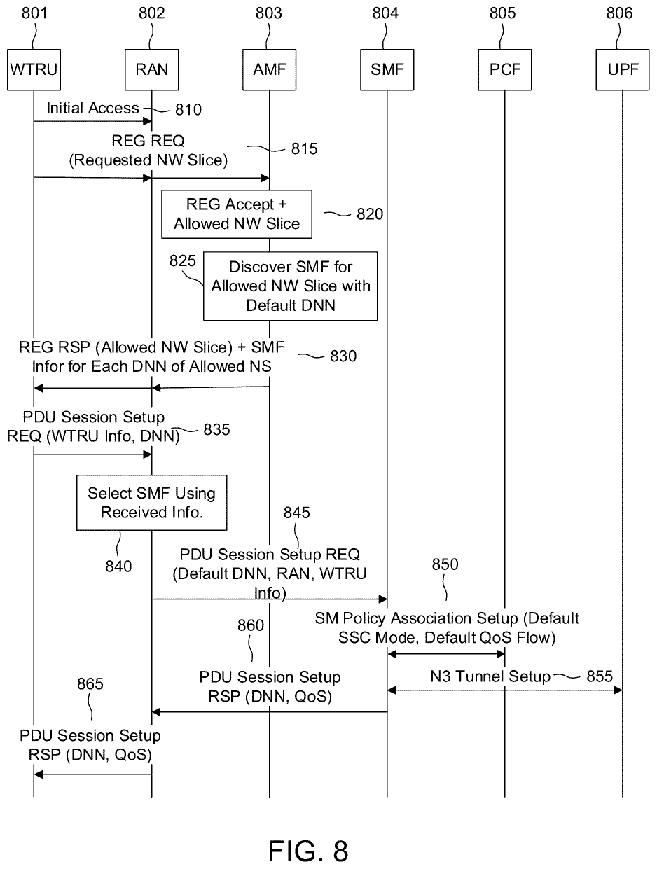

FIG. 8 shows an example procedure for default PDU session setup by a RAN node per allowed network slice.

When a WTRU 801 enters a new service area, the WTRU may perform an initial access procedure 810 with a RAN node 802 (e.g., gNB).

After the initial access procedure with the RAN node, the WTRU may send a registration request (REG REQ) message 815 to the network (e.g., AMF 803) for initial registration. The registration request may include the WTRU's identification information and requested network (NW) slice information which the WTRU wants or requests to get communication services.

The AMF may verify whether the WTRU may register (REG accept) at the network 820. If needed (e.g., there is no established security context for the WTRU with the network or the security context for the WTRU with the network has expires), an authentication and authorization procedure may be performed by the network function with the WTRU via the AMF. The AMF may check or determine the allowed network slice information for the WTRU (with another NW function if the network slice context is authorized or managed by the other NW function).

The AMF may check or determine the default DNN and default PDU session parameter information for each allowed network slice information. Based on the default DNN and default PDU session parameter information, the AMF may discover 825 an SMF 804 which controls the PDU session for the default DNN of the allowed network slice(s) and may select a proper SMF to control the PDU session for the WTRU (e.g. based on various factor such as load, location, etc.).

If the SMF has a service area, the AMF may also verify that the service area of the SMF may serve the WTRU.

The AMF may send a registration response (REG RSP) message 830 with allowed network slice information to the WTRU via the RAN node. When the AMF sends a registration response message, the AMF may send discovered SMF information for the default DNN for each allowed network slice of the WTRU to the RAN node.

The RAN node may utilize the SMF information received for forwarding PDU session management signaling for the WTRU or other PDU session establishment signaling for the DNN from other WTRUs.

In an embodiment, the RAN node may send a PDU session setup request message for the default DNN for an allowed NW slice. In this case, step 835 may be skipped.

The WTRU may send a PDU session setup request (REQ) message 835 for the DNN for the allowed network slice. The message may include the WTRU's ID and requested DNN information. When sending the PDU session setup request message, the WTRU may include the DNN information and PDU session ID as additional information to be decodable at the RAN node so that at step 840, the RAN node may utilize the information for selection of a proper SMF.

If multiple DNNs are assigned for an allowed network slice, the WTRU may send individual PDU session setup request messages for different DNN.

After receiving a PDU session setup request message, the RAN node may select 840 an SMF for forwarding the request message based on the received SMF's information with the associated DNN at step 830.

After forwarding the PDU session setup request message to the selected SMF, the RAN node may store the mapping or association of the PDU session ID, DNN, and SMF information so that RAN node may select the same SMF for further signaling relating session management (e.g., PDU session modification, PDU session release, etc.).

The RAN node may send a PDU session setup request (REQ) message 845 to the selected SMF. The message may include the DNN information, RAN node information and WTRU's information. The message may include N3 Tunnel information by the RAN node.

After receiving the PDU session setup request message, the SMF may retrieve the PDU session parameters for the requested DNN 850 from a PCF 805. The PDU session parameters may be, for example, SSC mode and/or QoS flows (e.g., default QoS flow).

Based on the PDU session parameters, the SMF may select a UPF 806 for traffic handling for the PDU session and request an N3 tunnel setup for the WTRU's PDU session using the RAN node's N3 tunnel information 855. Based on the RAN node's N3 tunnel information, the UPF may setup an N3 tunnel with the RAN node for downlink traffic.

The SMF may send a PDU session setup response (RSP) message 860 to the RAN node based on the received information from the AMF. In the PDU session setup response message, QoS flow and QoS parameter information may be included. The UPF's tunnel end point information may be included in the response.

The RAN node may send a PDU session setup response (RSP) message 865 to the WTRU. The message may include assigned QoS flows for the default DNN and other associated parameters. The RAN node may setup an uplink N3 tunnel based on the UPF's tunnel end point information.

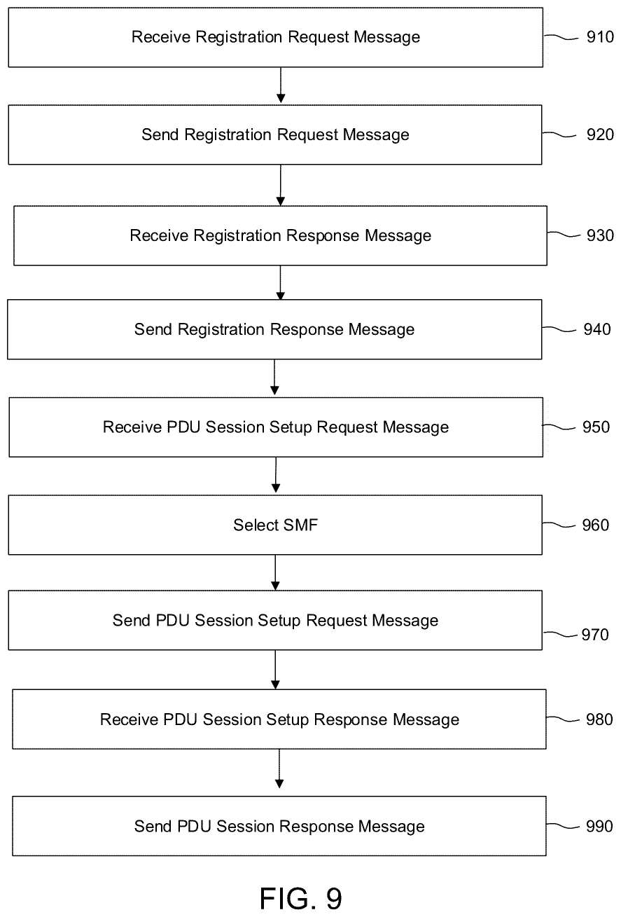

FIG. 9 shows an example procedure for use in a RAN node for default PDU session setup by a RAN node per allowed network slice.

The RAN node may receive a registration request message 910. The registration request message may be received from a WTRU. The registration request message may include the WTRU's identification information. The registration request message may include requested network slices.

The RAN node may send the registration request message 920. The RAN node may send the registration request message to an AMF. The registration request message may include the requested network slices.

The RAN node may receive a registration response message 930. (e.g., signaling message) The RAN node may receive the registration response message from the AMF. The registration response message may include the allowed network slices and SMF information for default DNNs for the allowed network slices.

The RAN node may store a mapping or association between SMF information, DNN information, and allowed network slices (which may be optional).

The RAN node may send a registration response message 940. The RAN node may send the registration response message to the WTRU. The registration response message may include the allowed network slice. The registration response message may include the allowed network slices and SMF information for default DNNs for the allowed network slices.

The RAN node may utilize the SMF information received for forwarding PDU session management signaling for the WTRU or other PDU session establishment signaling for the DNN from other WTRUs.

The RAN node may receive a PDU session setup request message 950. The RAN node may receive the PDU session setup request message from the WTRU. The request message may be for default DNN for the allowed network slice. The message may include the WTRU's ID and requested DNN information. The message may include the DNN information and PDU session ID as additional information to be decodable at the RAN node so the RAN node may utilize the information for selection of a proper SMF.

The RAN node may select an SMF 960. The RAN node may select an SMF based on a stored mapping or association between the SMF and DNN information.

The RAN node may send a PDU session setup request message 970. The RAN node may send the PDU session setup request message to the selected SMF. The RAN node may store a mapping or association between the PDU session ID, DNN information, and SMF information. This may allow the RAN node to select the same SMF for further signaling relating session management (e.g., PDU session modification, PDU session release, etc.). The message may include the DNN information, RAN node information and WTRU's information. The message may include N3 tunnel information by the RAN node.

The RAN node may receive a PDU session setup response message 980. The RAN node may receive the PDU session setup response message from the SMF. The PDU session setup response message may include QoS flow and QoS parameter information. A UPF's tunnel end point information may be included in the message.

The RAN node may send a PDU session response message 990. The RAN node may send the PDU session response message to the WTRU. The message may include assigned QoS flows for the default DNN and other associated parameters. The RAN node may setup an uplink N3 tunnel based on the UPF's tunnel end point information.

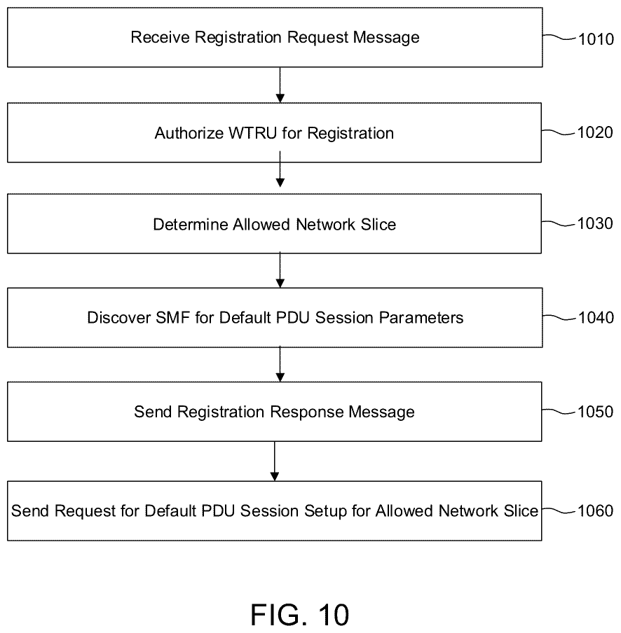

FIG. 10 shows an example procedure for use in an AMF node for default PDU session setup by a RAN node per allowed network slice.

The AMF may receive a registration request message 1010. The registration request message may be received from a WTRU. The registration request message may be received from a RAN node on behalf of the WTRU (i.e. the registration request message is sent from the WTRU to the RAN node, which forwards the registration request message to the AMF). The registration request message may include requested network slices (e.g., requested from the WTRU). The registration request message may include the WTRU's identification information and requested network slice(s)information for which the WTRU wants to get communication services. For each requested network slice, the WTRU may indicate whether a default PDU session is preferred or requested.

The AMF may authorize the WTRU for the registration 1020.

The AMF may determine the allowed network slice 1030.

The AMF may discover an SMF 1040 for a default PDU session for the allowed network slice. The AMF may check or determine the default DNN and default PDU session parameter information for each allowed network slice information. Based on the default DNN and default PDU session parameter information, the AMF may discover an SMF which controls the PDU session for the default DNN of the allowed network slice(s) and may select a proper SMF to control the PDU session for the WTRU (e.g. based on various factor such as load, location, etc.). [0162] If the SMF has a service area, the AMF may also verify that the service area of the SMF may serve the WTRU.

The AMF may send a registration response message 1050. The AMF may send the registration response message to the WTRU and/or RAN node. The registration response message may include the allowed network slice and SMF information for the default DNN for the allowed network slice.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a radio access network (RAN) node, the method comprising:
receiving a first registration request from a wireless transmit/receive unit (WTRU), wherein the first registration request comprises a requested network slice;
sending a second registration request, wherein the second registration request comprises information indicating the requested network slice;
receiving a first registration response, wherein the first registration response comprises information indicating allowed network slice information;
sending a second registration response, wherein the second registration response comprises allowed network slice information;
receiving a first protocol data unit (PDU) session setup response, wherein the first PDU session setup response comprises quality of service (QoS) flow and QoS parameter information associated with an allowed network slice;
setting up a user plane tunnel between the RAN node and a gateway associated to a default PDU session; and
sending a second PDU session setup response, wherein the second PDU session setup response comprises information regarding assigned QoS flows for a default data name network (DNN) for the allowed network slice.

2. The method of claim 1, wherein the first registration request comprises a WTRU identification.

3. The method of claim 1, wherein the first registration request comprises an indication that a default PDU session is requested.

4. The method of claim 3, wherein the second registration request comprises information for tunnel setup for the default PDU session for the requested network slice.

5. The method of claim 1, wherein the second registration request is sent to an Access and Mobility Function (AMF) and the first registration response is received from the AMF.

6. The method of claim 1, wherein the first registration response comprises Session Management Function (SMF) information for default data network name (DNN) for an allowed network slice.

7. The method of claim 6, further comprising:
forwarding PDU session management messages based on the SMF information.

8. The method of claim 1, wherein the first PDU session setup response is received from a Session Management Function (SMF).

9. The method of claim 1, wherein the first PDU session setup response is a session management (SM) non-access stratum (NAS) message.

10. The method of claim 1, wherein the first PDU session setup response comprises User Plane Function (UPF) tunnel endpoint information.

11. A radio access network (RAN) node comprising:
a transceiver; and
a processor, wherein:
the transceiver is configured to receive a first registration request from a wireless transmit/receive unit (WTRU), wherein the first registration request comprises a requested network slice;
the transceiver is further configured to send a second registration request, wherein the second registration request comprises information indicating the requested network slice;
the transceiver is further configured to receive a first registration response, wherein the first registration response comprises information indicating allowed network slice information;
the transceiver is further configured to send a second registration response, wherein the second registration response comprises allowed network slice information;
the transceiver is further configured to receive a first protocol data unit (PDU) session setup response, wherein the first PDU session setup response comprises quality of service (QoS) flow and QoS parameter information associated with an allowed network slice;
the processor is configured to set up a user plane tunnel between the RAN node and a gateway associated to a default PDU session; and
the transceiver is further configured to send a second PDU session setup response to the WTRU, wherein the second PDU session setup response comprises information regarding assigned QoS flows for a default data name network (DNN) for the allowed network slice.

12. The RAN node of claim 11, wherein the first registration request comprises a WTRU identification.

13. The RAN node of claim 11, wherein the first registration request comprises an indication that a default PDU session is requested.

14. The RAN node of claim 13, wherein the second registration request comprises information for tunnel setup for the default PDU session for the requested network slice.

15. The RAN node of claim 11, wherein the second registration request is sent to an Access and Mobility Function (AMF) and the first registration response is received from the AMF.

16. The RAN node of claim 11, wherein the first registration response comprises Session Management Function (SMF) information for default data network name (DNN) for an allowed network slice.

17. The RAN node of claim 16, wherein the transceiver is further configured to:
forwarding PDU session management messages based on the SMF information.

18. The RAN node of claim 11, wherein the first PDU session setup response is received from a Session Management Function (SMF).

19. The RAN node of claim 11, wherein the first PDU session setup response is a session management (SM) non-access stratum (NAS) message.

20. The RAN node of claim 11, wherein the first PDU session setup response comprises User Plane Function (UPF) tunnel endpoint information.
